(19) United States
(12) Patent Application Publication
(10) Pub. No.: US 2014/0120332 A1
(43) Pub. Date: May 1, 2014

(54) VaRTM Processing of Tackified Fiber/Fabric Composites

(71) Applicant: UNITED TECHNOLOGIES CORPORATION, Hartford, CT (US)

(72) Inventors: Joseph Jalowka, Broad Brook, CT (US); Charles R. Watson, Windsor, CT (US); Cristal Chan, Coventry, CT (US)

(73) Assignee: UNITED TECHNOLOGIES CORPORATION, Hartford, CT (US)

(21) Appl. No.: 13/661,354

(22) Filed: Oct. 26, 2012

(51) Int. Cl. B29C 70/44; B32B 27/04; B32B 5/26

(52) U.S. Cl. 428/212; 264/258; 264/571; 428/221; 428/196

(57) ABSTRACT

A process for forming a composite structure includes the steps of: providing a preform having a plurality of layers; applying a tackifier to each of the layers of the preform; and infusing the preform with a resin. The tackifier may be catalyzed or uncatalyzed, thermoset or thermoplastic resin. The tackifier has a strain capability greater than the strain of the resin which infuses the preform.

### BACKGROUND

The present disclosure describes a process for manufacturing composites using pressure enhanced vacuum assisted resin transfer molding (VaRTM) and the composites produced thereby.

Vacuum assisted resin transfer molding is a resin infusion process that utilizes dry fiber preforms, with a tool on one surface, and a vacuum/pressure bag on the opposite surface. The resin flows into the fibrous preform by drawing a vacuum (typically 25 to 28 inches of Hg) on the reinforcement plies contained within the bag. The pressure differential between the resin at atmospheric pressure and the vacuum on the reinforcement causes the resin to flow from a reservoir into the preform. The preform can either be heated, or at room temperature, depending on the viscosity of the resin. Once the preform is fully saturated with resin, the vacuum source is removed, and the inlet and outlet to the bag are closed and the resin is typically cured using heat. Vacuum assisted resin transfer molding processes typically require low viscosity resins in order to saturate the preforms.

This process also requires the resin viscosity to remain low during the entire infusion which could be greater than one hour depending on the size of the part. Formulation of low viscosity resins limits what can be added to the system and therefore affects the ultimate properties of the matrix material. Typically toughening of resins to improve their impact resistance requires the addition of components that significantly increase the resin viscosity, thus making their use as a vacuum assisted resin transfer molding resin impractical, if not impossible. Toughened resin systems have a wide range of applications in aerospace but especially for areas in which impact resistance and damage tolerance are required.

### SUMMARY

In accordance with the present disclosure, there is provided a process for forming a composite structure which broadly comprises the steps of: providing a preform having a plurality of layers; applying a tackifier to each of the layers of the preform; and infusing the preform with a resin.

In another and alternative embodiment, the preform providing step comprises providing a preform having layers formed from at least one of a fiber and a fabric.

In another and alternative embodiment, the tackifier applying step comprises applying a toughening resin which has a strain capability greater than the strain of the main resin.

In another and alternative embodiment, the tackifier applying step comprises applying the tackifier to selected locations on the layers, which selected locations are each shorter than a length of each layer.

In another and alternative embodiment, the tackifier applying step comprising applying the tackifier along an entire length of each layer.

In another and alternative embodiment, the plurality of layers includes two outer layers and at least one intermediate layer and the tackifier applying step comprises applying the tackifier to an inner surface of each of the outer layers and to two opposed surfaces of the at least one intermediate layer.

In another and alternative embodiment, the infusing step comprises infusing the preform with a thermoset resin matrix.

In another and alternative embodiment, the infusing step comprises infusing the preform with a resin selected from the group consisting of an epoxy resin, a bismaleimide resin, a polyimide resin, and mixtures thereof.

In another and alternative embodiment, the infusing step comprises: sealing the preform with the applied tackifier in a vacuum bag; placing the vacuum bag in contact with a heat source; infusing the main resin into the preform with the applied tackifier by drawing a vacuum on the preform with the applied tackifier; closing the flow of the main resin when the preform is filled; heating the preform with the applied tackifier and the infused main resin to a temperature that increases resin viscosity and allows the layers of the preform to be consolidated under pressure; applying external pressure to the preform; and opening the vacuum bag to allow residual main resin or entrapped gas to escape.

In another and alternative embodiment, the external pressure applying step comprises applying a pressure in the range of from a low pressure in the range of from 50 to 100 psi to high pressure in the ranges of thousands of psi.

In another and alternative embodiment, the process further comprises applying flow distribution media on exterior surfaces of the preform prior to infusing the main resin.

In another and alternative embodiment, the process further comprises heating the preform with the applied tackifier and the infused main resin to a cure temperature.

The present disclosure also relates to a composite which broadly comprises a preform having a plurality of layers; a tackifier applied to each of the layers; and an infused main resin located between the layers.

In another and alternative embodiment, each layer is formed from at least one of a fiber and a fabric.

In another and alternative embodiment, the tackifier comprises a resin material having a strength greater than the strength of the main resin.

In another and alternative embodiment, the plurality of layers includes two outer layers and at least one intermediate layer and wherein the tackifier is applied to an inner surface of each of the outer layers and two opposed surfaces of the at least one intermediate layer.

In another and alternative embodiment, the tackifier is applied to only select locations on each of the layers to form locally strengthened regions.

In another and alternative embodiment, the tackifier is applied along an entire length of each layer.

In another and alternative embodiment, the main resin is a thermoset resin matrix.

In another and alternative embodiment, the main resin is selected from the group consisting of an epoxy resin, a bismaleimide resin, a polyimide resin, and mixtures thereof.

### BRIEF DESCRIPTION OF THE DRAWINGS

FIG. 1 is a schematic representation of a dry preform;

FIG. 2 is a schematic representation of the preform of FIG. 1 with interlaced toughener/tackifier between layers of the preform;

FIG. 3 is a schematic representation of a composite having the preform with the interlaced toughener/tackifier between the layers of the preform and infused with resin; and

FIG. 4 is a schematic representation of the process used to form the composite of FIG. 3.

### DETAILED DESCRIPTION

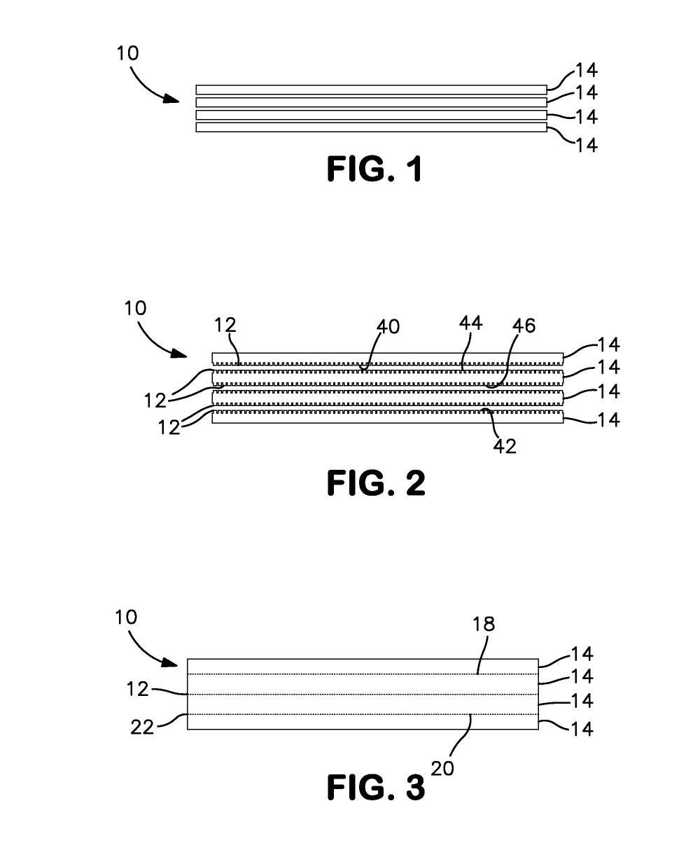

Referring now to FIG. 1, the process described herein makes use of dry reinforcements/preforms 10. The preforms 10 may have two outer layers 14 and one or more intermediate layers 14. The dry reinforcement/preforms 10 include, but are not limited to, layers 14 formed from one or more of tow, woven fabric, unidirectional fabric, braid, fiber, or 3D woven preforms. For example, the layers 14 of the preform 10 could be formed from carbon fibers, Fiberglass® E-or S glass fibers, Quartz, or Silicon Carbide (inorganic material in a fibrous condition or in the form of a loose mass of filaments or fibers), and/or Kevlar® fibers (man-made fibers).

In accordance with the process described herein, the fiber or fabric preform 10 is tackified or coated with a resin material which has a higher strain to failure than the main resin used to infuse the balance of the reinforcement. As shown in FIG. 2, the tackifier 12 may be located on interior surfaces 40 and 42 of the outer layers 14 and the opposed surfaces 44 and 46 of the intermediate layer(s) 14. The tackifier 12 may be formed by a toughening resin which has a strain capability greater than the strain of the main resin.

The tackifier 12 which may be used can be catalyzed or uncatalyzed, thermoset or thermoplastic. The tackifier only needs to be compatible with the chemistry of the resin used to infuse the preform stack. Suitable tackifiers include a thermoplastic resin or an epoxy resin modified to have a higher strength than a main epoxy resin used to infuse the layers 14 of the preform 10.

The tackifier 12 can be dispersed on the layers 14 of the reinforcement/preform 10 as a powder, in a film form coated on the layers 14 of the reinforcement, or as a veil laminated to the surfaces 40, 42, 44 and 46 of the layers 14 forming the preform 10. The percentage of the tackifier 12 used may depend on the fabric and/or fiber used for the layers 14 of the preform 10. Typically, the tackifier 12 would be present in an amount in the 5 to 10 wt % range based on the areal weight of the preform. The percentage of tackifier can also be changed to put more where it is needed to increase the toughness of the composite and less in areas where toughness is not a requirement. Furthermore, the tackifier 12 may be applied so as to cover all of the length of the surfaces 40, 42, 44, and 46 or so as to only cover selected regions of a respective surface 40, 42, 44, and/or 46, less than the entire length of the respective surface.

The presence of a tackifier 12 helps in laying up a part that has contour. The tackifier 12 can be locally heated during layup to facilitate in forming desirable shapes and contours. The chemistry of the tackifier 12 should provide some local tack during layup but should not go so low in viscosity that it might migrate during heat up for infusion.

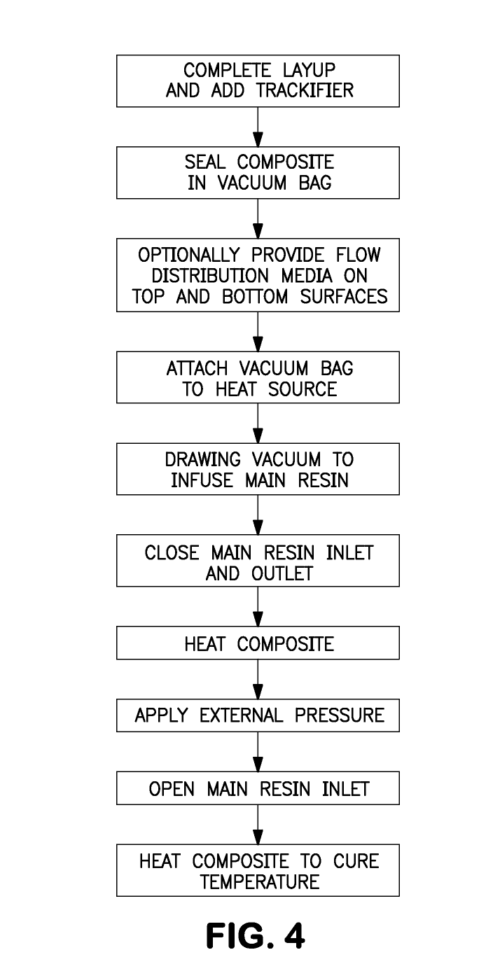

Referring now to FIG. 4, once the composite or preform layup is complete and the tackifier 12 has been added, as shown in FIG. 2, the composite with the preform 10 and the tackifier 12 is sealed in a vacuum bag. Flow distribution media may be provided on top and bottom surfaces 18 and 20 of the composite to help improve the permeability in the through thickness direction. The flow distribution media may be any open weave material which will survive the final cure temperature of the resin system, and has a much greater permeability than the preform being infused.

The vacuum bag can be attached to a heat source such as an integrally heated tool or can be placed into an autoclave or similar vessel. Main resin 22 may be infused into the preform 10 by drawing a vacuum on the fiber and/or fabric layup. Once the preform 10 fills, the main resin 22 appears in the outlet line, which is then closed along with the main resin inlet. The composite is heated to a temperature that increases the main resin viscosity to a level that is higher than typical for infusion but is still low enough to allow the plies/layers 14 of the composite to be consolidated under pressure. External pressure may be applied to the composite, and the main resin outlet from the bag is opened. The opening of the bag allows residual main resin or entrapped gas to escape the composite. The external pressure may be in the range of low pressures from 50 psi to 100 psi to high pressures in the range of thousands of psi. The external pressure causes compaction of the composite to the target fiber volume. The composite is then heated up to the cure temperature.

The composite, as shown in FIG. 3, may comprise layers 14 of fibers and/or fabric, the tackifier 12 joined to the layers 14, and layers 22 of main resin intermediate the layers 14 with the tackifier 12.

Fiber volumes in excess of 60% and void volumes less than 2% may be achieved using the process described herein. This makes the process acceptable for structural composite components that require impact resistance and damage tolerance. For example, the process described herein could be used to form lighter weight fan containment cases.

As can be seen from the foregoing discussion, by selecting an appropriate tackifier and level, the properties of the overall composite performance can be tailored. Segments of the part can be locally toughened to increase damage tolerance, while other areas that do not need this requirement can be unmodified. This can be done by providing the tackifier 12 in selected portions of the preform 10 where toughening or strengthening is required. By having a functionally graded preform, a designer can achieve a mechanical performance while optimizing the structure for weight.

The main resin 22 may comprise any suitable thermoset resin matrix type known in the art including, but not limited to, an epoxy resin, a bismaleimide resin, a polyimide resin, and mixtures thereof.

There has been described herein the VaRTM processing of tackified fiber/fabric composites. While the processing has been described in the context of specific embodiments thereof, other unforeseen alternatives, modifications, and variations may become apparent to those skilled in the art having read the foregoing description. Accordingly, it is intended to embrace those alternatives, modifications, and variations as fall within the broad scope of the appended claims.

1. A process for forming a composite structure comprising the steps of:
providing a preform having a plurality of layers;
applying a tackifier to each of the layers of the preform; and
infusing the preform with a main resin.

2. The process of claim 1 wherein the preform providing step comprises providing a preform having layers formed from at least one of a fiber and a fabric.

3. The process of claim 1, wherein said tackifier applying step comprises applying a toughening resin which has a strain capability greater than the strain of the main resin.

4. The process of claim 1, wherein said tackifier applying step comprises applying said tackifier to selected locations on the layers, which selected locations are each shorter than a length of each layer.

5. The process of claim 1, wherein said tackifier applying step comprising applying said tackifier along an entire length of each layer.

6. The process of claim 1, wherein said plurality of layers includes two outer layers and at least one intermediate layer and said tackifier applying step comprises applying said tackifier to an inner surface of each of said outer layers and to two opposed surfaces of said at least one intermediate layer.

7. The process of claim 1, wherein said infusing step comprises infusing said preform with a thermoset resin matrix.

8. The process of claim 1, wherein said infusing step comprises infusing said preform with a resin selected from the group consisting of an epoxy resin, a bismaleimide resin, a polyimide resin, and mixtures thereof.

9. The process of claim 1, wherein said infusing step comprises:
sealing said preform with said applied tackifier in a vacuum bag;
placing the vacuum bag in contact with a heat source;
infusing the main resin into the preform with the applied tackifier by drawing a vacuum on the preform with the applied tackifier;
closing the flow of the main resin when said preform is filled;
heating the preform with the applied tackifier and the infused main resin to a temperature that increases resin viscosity and allows the layers of the preform to be consolidated under pressure;
applying external pressure to the preform; and
opening the vacuum bag to allow residual main resin or entrapped gas to escape.

10. The process of claim 9, wherein said external pressure applying step comprises applying a pressure in the range of low pressures from 50 psi to 100 psi to high pressures in the thousands of psi.

11. The process of claim 9, further comprising applying flow distribution media on exterior surfaces of the preform prior to infusing the main resin.

12. The process of claim 9, further comprising heating the preform with the applied tackifier and the infused main resin to a cure temperature.

13. A composite comprising:
a preform having a plurality of layers;
a tackifier applied to each of said layers, wherein said tackifier is applied to only select locations on each of said layers to form locally strengthened regions; and
an infused main resin located between said layers.

14. The composite of claim 13, wherein each said layer is formed from at least one of a fiber and a fabric.

15. The composite of claim 13, wherein said tackifier comprises a resin material having a strain capability greater than a strain of said main resin.

16. The composite of claim 13, wherein said plurality of layers includes two outer layers and at least one intermediate layer and wherein said tackifier is applied to an inner surface of each of said outer layers and two opposed surfaces of said at least one intermediate layer.

17. (canceled)

18. The composite of claim 13, wherein said tackifier is applied along an entire length of each layer.

19. The composite of claim 13, wherein said main resin is a thermoset resin matrix.

20. The composite of claim 13, wherein said main resin is selected from the group consisting of an epoxy resin, a bismaleimide resin, a polyimide resin, and mixtures thereof.
